(19) United States
(12) Patent Application Publication
(10) Pub. No.: US 2022/0229212 A1
(43) Pub. Date: Jul. 21, 2022

(54) TRANSPARENT ELEMENT WITH DIFFUSE REFLECTION

(71) Applicant: SAINT-GOBAIN GLASS FRANCE, COURBEVOIE (FR)

(72) Inventors: Patrick GAYOUT, VILLEMOMBLE (FR); Cécile OZANAM, PALAISEAU (FR); Romain HIVET, SAINT-OUEN (FR); Benoît RUFINO, COURTIEUX (FR)

(21) Appl. No.: 17/605,156

(22) PCT Filed: Apr. 27, 2020
(86) PCT No.: PCT/EP2020/061629

§ 371 Date: Oct. 20, 2021

(30) Foreign Application Priority Data
Apr. 30, 2019 (FR) 1904536

(51) Int. Cl. G02B 5/02; G03B 21/60; B32B 17/10

(52) U.S. Cl. CPC G02B 5/0236; B32B 2457/20; G02B 5/0268; G03B 21/60; B32B 17/10036; B32B 17/10146; B32B 17/10201; B32B 17/10229; B32B 2307/412; B32B 2307/204; B32B 2307/418; B32B 2307/402; B32B 2307/202; B32B 2605/006; G02B 5/0284

(57) ABSTRACT

A process for producing a transparent layered element exhibiting a diffuse reflection property, to this layered element as such and to the use thereof in a plurality of industrial applications. There is also provided a projection or back-projection method implementing such a layered element.

The present invention relates to a process for producing a transparent layered element exhibiting a diffuse reflection property, to this layered element as such and to the use thereof in a plurality of industrial applications. The invention also relates to a projection or back-projection method implementing such a layered element.

The layered element may be rigid or flexible. It may in particular be a glazing unit, made for example based on glass or a polymer material. It may also be a flexible film based on polymer material, in particular one able to be added to a surface in order to confer diffuse reflection properties thereon while keeping its transmission properties.

Known glazing units comprise standard transparent glazing units, which give rise to specular reflection and specular transmission of a light ray incident on the glazing unit, and translucent glazing units, which give rise to diffuse reflection and diffuse transmission of a light ray incident on the glazing unit.

Conventionally, reflection from a glazing unit is said to be diffuse when a light ray incident on the glazing unit with a given angle of incidence is reflected by the glazing unit in a plurality of directions. Reflection from a glazing unit is said to be specular when a light ray incident on the glazing unit with a given angle of incidence is reflected by the glazing unit with an angle of reflection equal to the angle of incidence. Analogously, transmission through a glazing unit is said to be specular when a light ray incident on the glazing unit with a given angle of incidence is transmitted by the glazing unit with an angle of transmission equal to the angle of incidence.

One drawback of standard transparent glazing units is that they return clear reflections, in the manner of mirrors, which is not desirable in certain applications. Thus, when a glazing unit is used for a building window or a display screen, it is preferable to limit the presence of reflections, which decrease visibility through the glazing unit. Clear reflections off a glazing unit may also create a risk of dazzling, with consequences in terms of safety, for example when vehicle headlights are reflected off glazed budding façades. This is especially a problem for glazed airport façades. Specifically, it is critical to limit, as much as possible, the risk of dazzling pilots as they approach terminals.

Meanwhile, translucent glazing units, while they have the advantage of not generating clear reflections, do not allow a clear view through the glazing unit.

To overcome these drawbacks, it is known practice in the prior art, which includes document WO2012104547A1, to implement a transparent layered element exhibiting diffuse reflection which comprises two smooth outer main surfaces, and:
two outer layers, a lower outer layer and an upper outer layer, which each form one of the two outer main surfaces of the layered element and which consist of dielectric materials that have substantially the same refractive index, and
a laminar assembly inserted between the outer layers, this central layer being formed either by a single layer which is a dielectric layer with a refractive index different from that of the outer layers, or a metal layer, or by a stack of layers which comprises at least one dielectric layer with a refractive index different from that of the outer layers, or a metal layer,
   where each contact surface between two adjacent layers of the layered element, one of which is dielectric and the other of which is metal, or which are two dielectric layers with different refractive indices, is textured and parallel to the other textured contact surfaces between two adjacent layers, one of which is dielectric and the other of which is metal, or which are two dielectric layers with different refractive indices.

The transparent substrate may be formed, in particular, of transparent polymer, transparent glass or transparent ceramic. When the transparent substrate is composed of polymer, it may be rigid or flexible. In the form of a flexible film, such a transparent substrate is advantageously provided, on one of its outer main surfaces, with an adhesive layer covered with a protective strip intended to be removed for the adhesive bonding of the film. The layered element in the form of a flexible film is then suitable for being added by adhesive bonding to an existing surface, for example a surface of a glazing unit, in order to confer, on this surface, diffuse reflection properties, while maintaining specular transmission properties.

Each outer layer of the layered element may be formed by a stack of layers, as long as the various constituent layers of the outer layer are composed of dielectric materials all having substantially the same refractive index.

Within the meaning of the invention, what is understood by a dielectric material or layer is a material or layer with a low electrical conductivity, lower than 100 S/m.

The term “index” refers to the optical refractive index measured at a wavelength of 550 nm.

Within the meaning of the invention, two dielectric materials have substantially the same refractive index or have refractive indices that are substantially equal when the absolute value of the difference between their refractive indices at 550 nm is less than or equal to 0.15. Preferably, the absolute value of the refractive index difference at 550 nm between the constituent materials of the two outer layers of the layered element is smaller than 0.05 and better still smaller than 0.015.

Conversely, two dielectric layers have different refractive indices when the absolute value of the difference between their refractive indices at 550 nm is strictly larger than 0.15.

Throughout the description and regarding the composition of the laminar assembly, a distinction is made between metal layers, on the one hand, for which the refractive index value is inconsequential, and dielectric layers, on the other hand, for which the refractive index difference relative to that of the outer layers must be taken into account.

Within the meaning of the invention, the contact surface between two adjacent layers is the interface between the two adjacent layers.

In the context of the invention, the following definitions are used:
A transparent element is an element through which light rays are specularly transmitted at least in the wavelength ranges useful for the ultimate application of the element. By way of example, when the element is used in an architectural or automotive glazing unit, it is transparent at least in the visible wavelength range.
A smooth surface is a surface for which the surface irregularities have smaller dimensions than the wavelength of the incident radiation on the surface, so that the radiation is not deflected by these surface irregularities. The incident radiation is then transmitted and reflected specularly by the surface.
A textured surface is a surface the surface irregularities of which vary on a scale that is larger than the wavelength of the incident radiation on the surface. The incident radiation is then transmitted and reflected diffusely by the surface.

The parallelism of the textured contact surfaces implies that the or each constituent layer of the laminar assembly, which is dielectric and has a refractive index different from that of the outer layers, or which is a metal, has a uniform thickness perpendicular to the contact surfaces between the laminar assembly and the outer layers. This thickness may be uniform over the entire extent of the texture, or only locally over sections of the texture. In particular, when the texture comprises gradient variations, the thickness between two consecutive textured contact surfaces may change, in sections, depending on the slope of the texture, the textured contact surfaces however always remaining parallel to one another. This is especially the case for a layer deposited by cathode sputtering, the thickness of such a layer being inversely proportional to the slope of the texture. Thus, locally, in each section of texture having a given slope, the thickness of the layer remains constant, but the thickness of the layer differs between a first section of texture having a first slope and a second section of texture having a second slope different from the first slope.

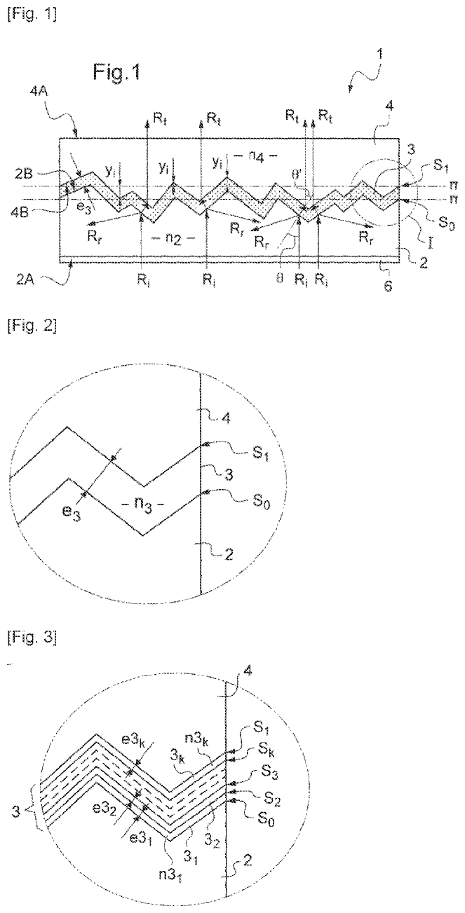

FIGS. 1 to 3 show such a transparent layered element known from the prior art. To ensure that the drawings are clear, the relative thicknesses of the various layers are not rigorously to scale. Furthermore, the possible variation in the thickness of each constituent layer of the laminar assembly with the slope of the texture has not been shown in the figures, it being understood that this possible variation in thickness does not have an impact on the parallelism of the textured contact surfaces. This is because, for each given slope of the texture, the textured contact surfaces are parallel to one another.

Throughout the description, the transparent layered element is regarded as being arranged horizontally, with its first face, directed downward, defining a lower outer main surface and its second face, opposite the first face, directed upward, defining an upper outer main surface; the meanings of the expressions “above” and “below” are thus to be considered with respect to this orientation. Unless specifically stipulated, the expressions “above” and “below'” do not necessarily mean that the two layers are positioned in contact with one another. The terms “lower” and “upper” are used here with reference to this arrangement.

It should be noted that the expression “comprised between . . . and . . . ” includes the limits in the interval.

The layered element 1 shown in FIG. 1 comprises two outer layers 2 and 4 which are composed of transparent dielectric materials having substantially the same refractive index n₂, n₄. Each outer layer 2 or 4 has a smooth main surface, 2A or 4A, respectively, directed toward the exterior of the layered element, and a textured main surface, 2B or 4B, respectively, directed toward the interior of the layered element.

The smooth outer surfaces 2A and 4A of the layered element 1 ensure light is transmitted specularly at each surface 2A and 4A, i.e. light rays enter into an outer layer or exit from an outer layer without changing direction.

The textures of the inner surfaces 2B and 4B are complementary to one another. As may clearly be seen in FIG. 1, the textured surfaces 2B and 4B are positioned facing each other, in a configuration in which their textures are strictly parallel to each other. The layered element 1 also comprises a laminar assembly 3 inserted between and making contact with the textured surfaces 2B and 4B.

In the variant shown in FIG. 2, the laminar assembly 3 is a monolayer and is composed of a transparent material that is either a metal, or dielectric of refractive index n3 different from that of the outer layers 2 and 4. In the variant shown in FIG. 3, the laminar assembly 3 is formed by a transparent stack of a plurality of layers 3¹, 3², . . . , 3^{k}, in which at least one of the layers 3¹ to 3k is either a metal layer or a dielectric layer of refractive index different from that of the outer layers 2 and 4. Preferably, at least each of the two layers 3¹ and 3k located at the ends of the stack is a metal layer or a dielectric layer of refractive index n₃₁ or n₃ₖ different from that of the outer layers 2 and 4.

In FIGS. 1 to 3, S₀ marks the contact surface between the outer layer 2 and the laminar assembly 3 and S₁ marks the contact surface between the laminar assembly 3 and the outer layer 4. Furthermore, in FIG. 3, S₂ to Sₖ successively denote the internal contact surfaces of the laminar assembly 3, starting from the contact surface closest to the surface S₀.

In the variant of FIG. 2, because the laminar assembly 3 is placed between and makes contact with the textured surfaces 2B and 4B, which are parallel to one another, the contact surface S₀ between the outer layer 2 and the laminar assembly 3 is textured and parallel to the contact surface S₁ between the laminar assembly 3 and the outer layer 4. In other words, the laminar assembly 3 is a textured layer exhibiting, at least locally, a uniform thickness e3, measured perpendicularly to the contact surfaces S₀ and S₁.

In the variant of FIG. 3, each contact surface S₂, . . . , Sₖ between two adjacent layers of the constituent stack of the laminar assembly 3 is textured and strictly parallel to the contact surfaces S₀ and S₁ between the outer layers 2, 4 and the laminar assembly 3. Thus, all of the contact surfaces S₀, S₁, . . . , Sₖ between adjacent layers of the element 1 that are either of different natures, dielectric or metal, or dielectric with different refractive indices, are textured and parallel to one another. In particular, each layer 3¹, 3², . . . , 3^{k} of the constituent stack of the laminar assembly 3 exhibits, at least locally, a uniform thickness e₃₁, e₃₂, . . . , e₃ₖ, taken perpendicularly to the contact surfaces S₀, S₁, . . . , Sₖ.

As shown in FIG. 1, the texture of each contact surface S₀, S₁ or S₀, S₁, . . . , Sₖ of the layered element 1 is formed by a plurality of recessed or projecting patterns, with respect to a general plane π of the contact surface.

FIG. 1 illustrates the route of a ray which is incident on the layered element 1 on the side of the outer layer 2. The incident rays Ri arrive perpendicular to the outer layer 2. As shown in figure the incident rays Ri, when they reach the contact surface S₀ between the outer layer 2 and the laminar assembly 3, with a given angle of incidence θ, are reflected either by the metallic surface or as a result of the difference in refractive index at this contact surface respectively between the outer layer 2 and the laminar assembly 3, in the variant of FIG. 2, and between the outer layer 2 and the layer 31, in the variant of FIG. 3. Since the contact surface S₀ is textured, the reflection takes place in a plurality of directions Rr. The reflection of the radiation by the layered element 1 is thus diffuse.

A portion of the incident radiation is also refracted in the laminar assembly 3. In the variant of FIG. 2, the contact surfaces S₀ and S₁ are parallel to one another, which implies, according to Snell's law, that n₂·sin(θ)=n₄·sin(θ′), where θ is the angle of incidence of the light ray on the laminar assembly 3 starting from the outer layer 2 and θ′ is the angle of refraction of the light ray in the outer layer 4 starting from the laminar assembly 3. In the variant of FIG. 3, since the contact surfaces S₀, S₁, . . . , Sₖ are all parallel to one another, the relationship n₂·sin(θ)=n₄·sin(θ′) resulting from Snell's law remains satisfied. Consequently, in both variants, as the refractive indices n₂ and n₄ of the two outer layers are substantially equal to one another, the rays Rt transmitted by the layered element are transmitted with an angle of transmission θ′ equal to their angle of incidence θ on the layered element. The transmission of rays by the layered element 1 is thus specular.

Similarly, in both variants, a ray incident on the layered element 1 on the side of the outer layer 4 is reflected in diffuse fashion and transmitted in specular fashion by the layered element, for the same reasons as above.

As is known, and as specified in document WO2012104547A1, a layered element such as described above may be obtained via a production process comprising the following steps:

a) a transparent substrate is provided (S₁), by way of a lower outer layer 2, one of the main surfaces 2B of which is textured and the other main surface 2A of which is smooth;
b) a laminar assembly 3 is deposited S2 on the textured main surface 2B of the lower outer layer 2 either, when the laminar assembly 3 is formed by a single layer that is a dielectric layer with a refractive index different from that of the outer layer 2 or a metal layer, by depositing the laminar assembly 3 conformally on said textured main surface 2B, or, when the laminar assembly 3 is formed by a stack of layers (3¹, 3², . . . , 3^{k}) comprising at least one dielectric layer with a refractive index different from that of the first outer layer 2 or a metal layer, by depositing the layers (3¹, 3², . . . , 3^{k}) of the laminar assembly 3 in succession conformally on said textured main surface 2B;
c) the upper outer layer 4 is formed (S3) on that textured main surface 3B of the laminar assembly 3 which is opposite the lower outer layer 2, where the lower 2 and upper 4 outer layers are composed of dielectric materials having substantially the same refractive index.

The conformal deposition of the laminar assembly 3, whether it is a monolayer or formed by a stack of a plurality of layers, should preferably be carried out under vacuum, by magnetic-field-assisted cathode sputtering (referred to as “magnetron cathode sputtering”). This technique makes it possible in particular to deposit, on the textured surface 2B of the substrate 2, either the single layer conformally or the different layers of the stack in succession conform ally with respect to the texture. In other words, employing this technique ensures that the surfaces bounding the various layers are parallel to one another.

A particularity of a glazing unit incorporating a layered element such as described above is that its appearance is uniform over the entirety of its diffusely reflecting transparent surface. However, certain industrial applications require that a particular pattern be able to be made apparent through reflection from such a surface, for technical and/or esthetic reasons.

To address this need, the prior art, and in particular document WO2012104547A1, recommends projecting, onto this diffusely reflecting surface, a pattern in the form of an image.

However, a drawback of such a system is that it requires the use of a projector coupled to the glazing unit, which thereby makes the implementation thereof significantly more complex.

There is therefore a need to provide a glazing unit comprising a transparent surface that exhibits diffuse reflection which allows a distinct pattern to be made apparent through reflection, in a straightforward and autonomous manner.

The proposed technique enables this need to be addressed. More particularly, in at least one embodiment, the invention relates to a transparent layered element comprising at least one lower outer layer and one upper outer layer which each form a smooth outer main surface of the layered element, and which consist of dielectric materials that have substantially the same refractive index, said layered element being characterized in that:
said layered element comprises a laminar assembly inserted between the outer layers and formed of a plurality of intermediate layers, each intermediate layer being either a single layer which is a dielectric layer with a refractive index that is different from that of the outer layers or a metal layer, or a stack of layers which comprises at least one dielectric layer with a refractive index that is different from that of the outer layers or a metal layer,
each contact surface between two adjacent layers of the layered element, one of which is dielectric and the other of which is metal, or which are two dielectric layers with different refractive indices, is textured and parallel to the other contact surfaces, and
said laminar assembly exhibits, in reflection, at least two adjacent regions, the colors of which are distinct from one another.

In the present text, a laminar assembly is by definition formed of a plurality of laminae deposited in succession on a carrier. The concept of color combines the three psychosensory parameters involved in the establishment of its visual appearance, which are lightness, hue and saturation, these last two parameters being able to be combined in the concept of chromaticity. By varying these three parameters independently of each other, it is possible to achieve all imaginable color sensations. In this context, the various systems for describing a color, for example the color spaces of CIE 1931 or CIELAB 76 type or the types of coordinates chosen in each of them, are only different ways of defining the three parameters which describe this color. For purely descriptive and non-limiting purposes, the colors are defined throughout the description according to the CIELAB 76 (CIE 1976) space with, as source, average daylight (D65), and, as standard observer, the CIE 2° observer as defined by its trichromatic spectral components, representing the chromatic response of a standardized observer defined by the CIE in 1931, and by using the Cartesian coordinates (L*, a*, b*) where L* is the psychometric lightness (between 0 and 100), a* is the chromatic position on a green-red axis (between −500 and 500), and b* is the chromatic position on a blue-yellow axis (between −200 and 200).

In the present text, two colors are said to be distinct when the Delta E, calculated according to the CIELAB 76 (CIE 1976), CIE94, CIEDE 2000 or CMC 1:c (1984) spaces, is between 4.0 and 5.0, preferably between 2.0 and 4.0, preferably between 1.0 and 2.0, and more preferably between 1.0 and 2.0.

The color reflected by a specific region of the laminar assembly, when viewed from the front with respect to one of the outer main surfaces (2A, 4A), is dependent on the nature of the intermediate layers (3¹, 3², . . . , 3^{K}) of which it is composed, on the respective thicknesses of same, on the process of their deposition and/or on their order of arrangement. Thus, and as described in greater detail in the description, if, between two regions (A, B, C, D) of the laminar assembly, at least one of these parameters differs, there is a high probability that these two regions (A, B, C, D) will exhibit, in reflection, colors that are distinct from one another.

Thus, according to one particular embodiment (not illustrated), two intermediate layers (3¹, 3², . . . , 3^{K}) are of the same nature but differ in their respective thicknesses, or the process of their deposition. Because of these differences, the regions covered, respectively, by these layers will exhibit, in reflection, colors that are distinct from one another.

Nowadays, it is known practice to determine the color that may be obtained through reflection by means of simulation by varying one or more of these parameters, for example using modeling software such as ODE (WTheiss Hardware and Software), OptiLayer (Thin Films Software) or Essential MacLeod (Thin Film Center). The novel and inventive concept of the invention allows a person skilled in the art, on the basis of their general knowledge of modeling stacks of layers, to produce a transparent layered element that allows a distinct pattern to be made apparent through reflection, without requiring the implementation of an auxiliary projection system. Thus, just the reflection of sunlight off the diffusely reflecting transparent surface of this stack of layers is sufficient to reveal such a pattern.

According to one particular embodiment, at least one intermediate layer, referred to as the “pattern layer”, partially overlaps another intermediate layer, referred to as the “bottom layer”, the corresponding overlapping portion forming, in reflection, a region of which the color is distinct from at least one adjacent region.

In the present text, the concept of “overlap” is considered viewed from the front with respect to one of the outer main surfaces and therefore implies no particular order of arrangement, it being possible to consider the layered element from either of its outer main surfaces. The variations in the thickness, the nature and/or the arrangement of the intermediate layers forming the laminar assembly due to such an overlap explain how a color that is distinct, in reflection, from at least one adjacent region is obtained in this region of overlap.

According to particular embodiments of the invention, the laminar assembly may comprise a plurality of successive stacks allowing various patterns to be obtained, in different colors.

According to one particular embodiment, at least one first intermediate layer forms a cross-inclusion within a second intermediate layer, and in that said first and second intermediate layers exhibit, in reflection, colors that are distinct from one another.

In other words, the portion of the first intermediate layer, which forms a cross-inclusion, corresponds to the negative of the second intermediate layer.

According to one particular embodiment, at least one intermediate layer, preferably said bottom layer, is obtained by magnetic-field-assisted cathode sputtering (referred to as “magnetron cathode sputtering”) and/or in that at least one intermediate layer, preferably said pattern layer, is obtained by screen printing.

As specified in the prior art, which includes document WO2012104547A1, obtaining a parallelism of the various layers relative to one another is made complex, or even impossible, in the context of depositing the laminar assembly by wet deposition, by vacuum evaporation, via a chemical-vapor-deposition (CVD) process and/or via a sol-gel process. The parallelism of the textured contact surfaces inside the layered element is however essential if specular transmission through the element is to be obtained. In the specific technical context of the invention, there is therefore in the prior art a strong encouragement on the one hand to favor the deposition of the laminar assembly by magnetron cathode sputtering and, on the other hand, to exclude any other deposition technique known for not allowing textured layers that are parallel to one another to be obtained.

However, quite unexpectedly, the inventors have observed that depositing an intermediate layer by screen printing makes it possible to retain optical properties close to those of the laminar assemblies for which this intermediate layer is deposited by magnetron sputtering, in terms of both light transmission and reflection. Additionally, deposition by screen printing has the advantage of being relatively easy to implement, from a technical point of view, in particular in comparison with deposition by magnetron cathode sputtering.

In the context of depositing a pattern layer which partially overlaps a bottom layer and/or forms a cross-inclusion within same, deposition by screen printing in this way is particularly advantageous in that it makes locally depositing this pattern layer easier. It should be noted that such “partial” deposition of the central layer is highly complex to implement via other deposition techniques, including magnetron cathode sputtering. At the very least, such “partial” deposition of the central layer requires considerable technical means, thus making the invention more complex.

Several signs make it possible to identify that a layer, in this case an intermediate layer, has been deposited by screen printing. Firstly, no raster is visible, the layer having been deposited as “solid colors”. Furthermore, if the edge of a screen-printed layer is observed, it is sometimes possible to detect therein light zigzag hatching. This observed defect is known as sawtooth and is caused by the orientation of the meshes of the fabric with respect to the frame of the screen during printing.

According to one particular embodiment, said intermediate layer obtained by screen printing is a dense layer obtained by curing a sol-gel solution and comprising, after said curing, preferably grains of at least one metal oxide, preferably titanium oxide.

According to one particular embodiment, at least one outer layer is absorbent in the visible spectrum.

Such a layer is therefore dark in color, which makes it possible:
to enhance the visual effect of the reflection on the side on which the substrate is light, from which the observer perceives transmitted light only very slightly and reflected light prominently,
to attenuate the differences in colors in transmission on the side on which the substrate is dark, from which the observer hardly perceives reflected light, most of it being absorbed, but transmitted light prominently by virtue of the single path traveled by transmitted light through the dark element, instead of two for reflected light. The presence of a dark layer thus makes it possible to smooth the differences in colors in transmission between the various regions.

According to one particular embodiment, at least one intermediate layer, preferably said bottom layer, exhibits a zero saturation value.

A point exhibiting a zero saturation value will be gray, black or white, depending on lightness. In the context of an application in an optical system with a glass function, a region of zero saturation in transmission has no hue, and therefore has the advantage of not altering the hue of light rays transmitted from outside.

According to one alternative embodiment, the target chromaticity value has a non-zero saturation and therefore corresponds to a particular color to be obtained in transmission and/or in reflection, whether motivated by technical and/or esthetic reasons.

According to one particular embodiment, the intermediate layers are all conductive.

A functionality or, in other words, an additional use may then be added. The main function targeted here is the “solar control” function, i.e. exhibiting low energy transmission. The solar control function is conventionally obtained using at least one conductive layer (silver, ITO, TiN, etc.), and then exhibits high reflectivity in the infrared (800-2500 nm) while retaining transparency in the visible. However, the function may be obtained using at least one absorbent layer: absorbent either across the entire solar spectrum, or just in the infrared (800-2500 nm).

The invention also relates to a process for producing a layered element comprising the following steps:

a) a lower outer layer is provided, one of the main surfaces of which is textured and the other main surface of which is smooth;
b) a plurality of intermediate layers are deposited successively and conformally on said textured main surface, each intermediate layer being either a single layer which is a dielectric layer with a refractive index that is different from that of the outer layers or a metal layer, or a stack of layers which comprises at least one dielectric layer with a refractive index that is different from that of the outer layers or a metal layer, said intermediate layers forming, after deposition, a laminar assembly which exhibits, in reflection, at least two adjacent regions, the colors of which are distinct;
c) an upper outer layer is formed on that textured main surface of the laminar assembly which is opposite the lower outer layer, where the lower and upper outer layers are composed of dielectric materials having substantially the same refractive index.

In the context of the invention, the successive and conformal deposition of a plurality of intermediate layers makes it possible to ensure that each contact surface between two adjacent layers of the layered element one of which is dielectric and the other of which is metal, or which are two dielectric layers with different refractive indices, is textured and parallel to the other contact surfaces.

According to one particular embodiment, step b) of depositing the laminar assembly comprises at least:
depositing a first intermediate layer referred to as the “bottom layer”, then
depositing a second intermediate layer referred to as the “pattern layer”, such that this pattern layer partially overlaps said bottom layer, and that the corresponding overlapping portion forms, in reflection, a region of which the color is distinct from at least one adjacent region.

According to one particular embodiment, step b) of depositing the laminar assembly comprises at least:
depositing a first intermediate layer referred to as the “bottom layer”, such that it comprises a through-window, then
depositing a second intermediate layer referred to as the “pattern layer”, at least a portion of which is deposited in said through-window in the bottom layer, such that this pattern layer forms a cross-inclusion within said bottom layer, said first and second intermediate layers exhibiting, in reflection, colors that are distinct from one another.

According to one particular embodiment, in step b) of depositing the laminar assembly, at least one intermediate layer, preferably a bottom layer, is deposited by magnetron cathode sputtering.

According to one particular embodiment, in step b) of depositing the laminar assembly, at least one intermediate layer, preferably a bottom layer, is deposited by screen printing and comprises:

b1) positioning a screen-printing screen facing the textured main surface of the lower outer layer, and/or another intermediate layer of the laminar assembly,
b2) depositing a dielectric layer with a refractive index that is different from that of the outer layers or a metal layer on the screen-printing screen and transferring said layer onto the substrate, preferably using a squeegee.

According to one particular embodiment, the laminar assembly is formed by depositing, on the textured main surface of the lower outer layer, a layer which is initially in a viscous state suitable for shaping operations.

The layer initially deposited in a viscous, liquid or pasty state may be a layer of photocrosslinkable and/or photopolymerizable material. Preferably, this photocrosslinkable and/or photopolymerizable material is provided in liquid form at ambient temperature and gives, when it has been irradiated and photocrosslinked and/or photopolymerized, a transparent solid devoid of bubbles or any other irregularity. It may in particular be a resin, such as those normally used as adhesives or surface coatings. These resins are generally based on monomersicomonomers/prepolymers of epoxy, epoxysilane, acrylate, methacrylate, acrylic acid or methacrylic acid type. Mention may be made, for example, of thiolene, polyurethane, urethane-acrylate or polyester-acrylate resins. Instead of a resin, it may be a photocrosslinkable aqueous gel, such as a polyacrylamide gel.

According to one particular embodiment, the laminar assembly is formed by depositing, on the textured main surface of the lower outer layer, a sol-gel solution preferably comprising a precursor of a titanium oxide, preferably titanium tetraisopropanolate, and then curing this sol-gel solution.

The sol-gel process consists, in a first step, in preparing a solution referred to as “sol-gel solution” comprising precursors which give rise, in the presence of water, to polymerization reactions. When this sol-gel solution is deposited on a surface, due to the presence of water in the sol-gel solution or on contact with ambient moisture, the precursors hydrolyze and condense to form a network in which the solvent is trapped. These polymerization reactions result in the formation of increasingly condensed entities, which lead to colloidal particles forming sols and then gels. The drying and the densification of these gels, at a temperature of about a few hundred degrees, results, in the presence of silica-based precursor, in a sol-gel layer corresponding to a glass, the characteristics of which are similar to those of a conventional glass.

As a result of their viscosity, sol-gel solutions, in the form of a colloidal solution or of a gel, may be easily deposited on the textured main surface of the laminar assembly opposite the first outer layer, conforming to the texture of this surface.

The specific choice of a sol-gel layer to form the laminar assembly of the layered element makes it possible to precisely adjust the optical index thereof in order to adjust its reflectivity, to add a component that gives a colored appearance to the sol-gel layer, to apply the laminar assembly to complex surfaces of various sizes and without requiring heavy equipment, and to obtain depositions that are homogeneous in terms of surface, composition and thickness.

In particular, the inventors have surprisingly discovered that the specific use of a particular sol-gel layer to form the laminar assembly of the layered element makes it possible to easily prepare transparent layered elements with diffuse reflection having a given optical index, with an accuracy of 0.015. The sol-gel layer of the invention has, depending on the proportions of the various precursor compounds forming it, an adjustable refractive index. It is therefore possible to accurately adjust the refractive index so as to adjust its reflectivity.

The flexible formulation, in terms of index, of the sol-gel layer of the invention makes it possible to obtain transparent layered elements that have a constant quality in terms of optical performance, regardless of the provenance of the substrate or the nature of the substrate. Furthermore, it is also possible to use, as lower outer layer, plastic substrates having a significantly higher index.

To accurately adjust the refractive index of the sol-gel layer, the proportions of metal oxides originating from the matrix or dispersed in the form of particles are modified. As a general rule, metal oxides have a higher refractive index than that of the silica. By increasing the proportions of metal oxide, the refractive index of the sol-gel layer is increased.

It is therefore possible to theoretically determine the refractive index of a sol-gel layer according to the main compounds forming it and thus to theoretically determine the formulation of a sol-gel solution that will make it possible to obtain, after curing, a sol-gel layer having the required refractive index.

According to one particular embodiment, the drying temperature of the sol-gel solution is between 0 and 200° C., preferably between 100° C. and 150° C., preferably between 110° C. and 130° C.

According to one particular embodiment, the laminar assembly is deposited using a screen-printing screen equipped with a mesh of which the number of yarns per cm is between 50 and 150, preferentially between 75 and 125, preferentially between 85 and 115, preferentially between 90 and 110, preferentially between 95 and 105, preferentially between 99 and 101, and of which the yarn diameter in micrometers is between 24 and 72, preferentially between 36 and 60, preferentially between 42 and 54, preferentially between 45 and 51, preferentially between 47 and 49.

As is known, the number of yarns and their diameter make it possible to define the mesh size of the mesh. This mesh size has a direct influence on the thickness of the pattern printed by screen printing and on the resolution of the design.

The use of a mesh having the selection of number of yarns and of yarn diameter specified above makes it possible to deposit a laminar assembly, the thickness of which allows the laminar assembly, once cured, and more generally the layered element, to satisfy all of the technical criteria cited in the present description.

According to one particular embodiment, the laminar assembly as deposited has a thickness greater than the peak-to-valley value of the textured main surface of the lower outer layer.

Throughout the description, the thickness defined between the lowest valley and the highest peak or crest corresponds to the value known as the peak-to-valley value. According to the invention, the thickness of the laminar assembly as deposited is defined starting from the lowest valley of the textured main surface of the lower outer layer.

The deposition of a laminar assembly, the thickness of which is greater than this peak-to-valley value, makes it possible to ensure that the whole of the textured surface portion of the lower outer layer to be covered is actually coated. After curing, the laminar assembly should thus cover the whole of this textured surface portion.

According to one particular embodiment, the upper outer layer is formed by depositing, on that textured main surface of the laminar assembly which is opposite the lower outer layer:
either a layer which has substantially the same refractive index as the lower outer layer and which is initially in a viscous state suitable for shaping operations,
or a layer based on polymer material, suitable for being shaped against the textured main surface of the laminar assembly by compression/heating.

According to one particular embodiment, the production process comprises a step, subsequent to the deposition of the laminar assembly, of annealing this laminar assembly at a temperature above 550° C., preferentially above 600° C.

Such a minimum temperature selection makes it possible to limit the annealing time, and therefore to improve the chemical resistance of the annealed element, while limiting the risk of color change of the latter during the annealing step.

The invention also relates to a glazing unit for a vehicle, fora building, for street furniture, for interior furnishings, for a display screen and/or for a head-up display system, said glazing unit comprising such a layered element, said intermediate pattern layer being suitable for revealing a given pattern by reflection and/or transmission.

The glazing unit according to the invention is capable of being used for all known applications of glazing units, such as for vehicles, buildings, street furniture, interior furnishings, lighting, display screens, etc. It may also be a flexible film based on a polymer material, in particular capable of being added to a surface in order to give it diffuse reflection properties while preserving its transmission properties.

The layered element exhibiting high diffuse reflection of the invention may be used in a head-up display (HUD) system.

In the present text, a HUD system is understood to mean a system that makes it possible to display information projected onto a glazing unit, in general the windshield of the vehicle, which is reflected toward the driver or observer. Such HUD systems are in particular useful in airplane cockpits, trains, but also today in the motor vehicles of private individuals (cars, trucks, etc.). These systems make it possible to inform the driver of the vehicle without the latter having to look away from the forward field of view of the vehicle, which makes it possible to greatly increase safety.

In the context of the invention, a real image is formed on the screen (and not level with the road). The driver must therefore “refocus” their gaze on the windshield in order to read the information.

It should be noted that, in the HUD systems of the prior art, a virtual image is obtained by projecting the information onto a glazing unit (in particular a windshield) which has a wedge-shaped laminated structure formed of two glass sheets and a plastic interlayer. One drawback of these existing systems is that the driver then sees a double image, a first image reflected by the surface of the glazing unit oriented toward the inside of the passenger compartment and a second image by reflection of the outer surface of the glazing unit, these two images being slightly offset relative to one another. This offsetting may interfere with the viewing of the information.

The invention makes it possible to overcome this problem. Specifically, when the layered element is integrated into an HUD system, as a glazing unit or as flexible film added to the main surface of the glazing unit that receives the radiation from the source of projection, the diffuse reflection on the first textured contact surface encountered by the radiation in the layered element may be significantly higher than the reflection on the outer surfaces in contact with the air. Thus, the double reflection is limited by promoting reflection on the first textured contact surface of the layered element.

The invention also relates to a projection or back-projection method, according to which there is such a glazing unit, which is used as a projection or back-projection screen, and a projector, said method consisting in projecting, using the projector, images that are visible to viewers on one of the sides of said glazing unit.

According to one particular embodiment, the transparent layered element exhibits:
a haze in transmission, measured according to the standard ASTM D 1003, that is less than 10%, preferably less than 7%, preferably less than 3%,
a clarity, measured with a BYK Haze-Gard Plus, that is greater than 93%, preferably greater than 95% and preferably greater than 98%.

According to one particular embodiment, the thickness of the lower outer layer is preferably between 1 μm and 12 mm and varies according to the choice of the dielectric material.

According to one particular embodiment, at least one outer layer is a glass textured on a single side and has a thickness between 0.4 and 10 mm, preferably between 0.7 and 4 mm.

According to one particular embodiment, at least one outer layer is made of a polymer textured on a single side, for example a plastic film, and has a thickness between 0.020 and 2.000 mm, preferably between 0.025 and 0.500 mm.

According to one particular embodiment, at least one outer layer consists of a thermoplastic interlayer, preferentially of polyvinyl butyral (PVB), and has a thickness between 0.1 and 1.0 mm.

According to one particular embodiment, at least one outer layer consists of a layer of dielectric material and has a thickness between 0.2 and 20 μm, preferably between 0.5 and 2 μm.

According to one particular embodiment, at least one outer layer comprises curable materials initially in a viscous, liquid or pasty state, which are suitable for shaping operations and have a thickness between 0.5 and 100 μm, preferably between 0.5 and 40 μm, preferably between 0.5 and 15 μm.

According to one particular embodiment, at least one outer layer comprises photocrosslinkable and/or photopolymerizable materials which have a thickness between 0.5 and 20 μm, preferably between 0.7 and 10 μm.

According to one particular embodiment, each outer layer of the layered element is formed of a stack of sublayers consisting of materials all having substantially the same optical index. Alternatively, the interface between these sublayers may be either smooth, or textured.

The choice of the thickness of the laminar assembly depends on a certain number of parameters. Generally, it is considered that the total thickness of the laminar assembly is between 5 and 200 nm, and the thickness of an intermediate layer of the laminar assembly is between 1 and 200 nm.

According to one particular embodiment, the laminar assembly is a metal layer, the thickness of which is between 5 and 40 nm, preferentially between 6 and 30 nm and more preferentially between 6 and 20 nm.

According to one particular embodiment, the laminar assembly is a dielectric layer, for example of TiO₂, and has a thickness between 20 and 100 nm, and more preferentially between 45 and 75 nm and/or a refractive index of between 2.2 and 2.4.

According to one particular embodiment, the layers of sol-gel nature are deposited by a screen-printing process and have a thickness before annealing/in the liquid state between 0.5 and 50 μm, preferably between 5 and 25 μm, preferably between 10 and 15 μm.

According to the particular embodiment of the invention, the laminar assembly is deposited on one portion only of the textured main surface of the lower outer layer. The bottom and pattern layers are therefore added only to this portion of the lower outer layer.

According to one particular embodiment, the smooth outer main surfaces of the layered element and/or the smooth outer main surfaces of the glazing unit are flat or curved and, preferably, these smooth outer main surfaces are parallel to one another. This helps to limit the light dispersion for a ray passing through the layered element, and therefore to improve the clarity of vision through the layered element.

Other features and advantages of the invention will become apparent on reading the following description of particular embodiments, which are provided by way of simple illustrative and non-limiting examples, and the appended figures, in which:

FIG. 1 is a schematic cross section of a layered element known from the prior art;

FIG. 2 is a view on a larger scale of the detail I in FIG. 1 for a first variant of the layered element known from the prior art;

FIG. 3 is a view on a larger scale of the detail I in FIG. 1 for a second variant of the layered element known from the prior art;

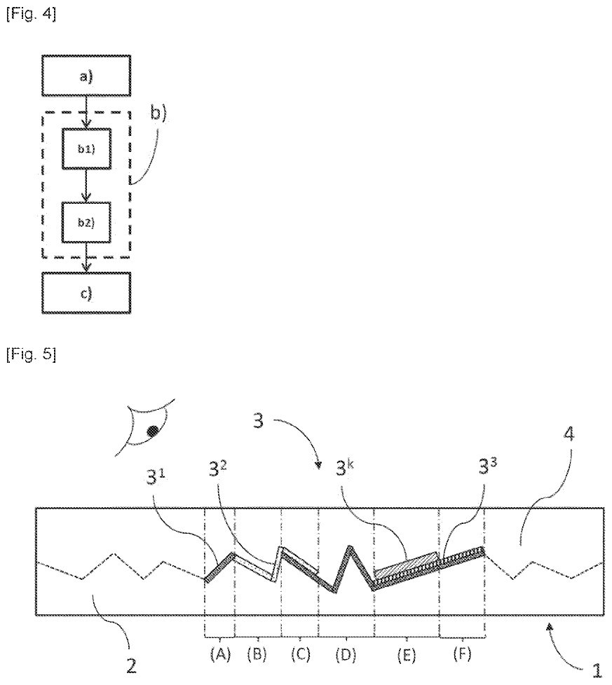

FIG. 4 is a flowchart illustrating the various steps in a process for producing a layered element according to one particular embodiment of the invention; and

FIG. 5 is a schematic cross section of a layered element according to one particular embodiment of the invention.

The various elements illustrated in the figures are not necessarily shown to actual scale, emphasis being more placed on the representation of the general operation of the invention.

In the various figures, unless otherwise indicated, identical reference numbers represent elements that are similar or identical.

A plurality of particular embodiments of the invention are presented below. It will be understood that the present invention is in no way limited by these particular embodiments and that other embodiments may perfectly well be implemented.

According to one particular embodiment of the invention, and as illustrated by FIG. 4, the process for producing a layered element comprises the following steps:

a) a lower outer layer (2) is provided, one of the main surfaces (2B) of which is textured and the other main surface (2A) of which is smooth;
b) a plurality of intermediate layers (3¹, 3², . . . , 3^{K}) are deposited successively and conformally on said textured main surface (2B), each intermediate layer (3¹, 3², . . . , 3^{K}) being either a single layer which is a dielectric layer with a refractive index (n3) that is different from that of the outer layers or a metal layer, or a stack of layers (3¹, 3², . . . , 3^{K}) which comprises at least one dielectric layer with a refractive index that is different from that of the outer layers or a metal layer, said intermediate layers (3¹, 3², . . . , 3^{K}) forming, after deposition, a laminar assembly (3) which exhibits, in reflection, at least two adjacent regions (A, B . . . ), the colors of which are distinct;
c) an upper outer layer (4) is formed on that textured main surface (3B) of the laminar assembly (3) which is opposite the lower outer layer (2), where the lower (2) and upper (4) outer layers are composed of dielectric materials having substantially the same refractive index.

Examples of glass substrates which may be used directly as the outer layer of the layered element comprise:
glass substrates sold by Saint-Gobain Glass in the SATINOVO® range, which are pretextured and exhibit, on one of their main surfaces, a texture obtained by sandblasting or acid attack;
glass substrates sold by Saint-Gobain Glass in the ALBARINO® S, P or G ramie or in the MASTERGLASS® range, which exhibit, on one of their main surfaces, a texture obtained by rolling;
high index glass substrates which are textured by sandblasting, such as flint glass, for example sold by Schott under the references SF6 (n=1.81), 7SF57 (n=1.85), N-SF66 (n=1.92) and P-SF68 (n=2.00).

Examples of central layers that may be inserted between the outer layers include thin dielectric layers, chosen from oxides, nitrides or halides of one or more transition metals, non-metals or alkaline-earth metals, in particular layers of Si₃N₄, SnO₂, ZnO, ZrO₂, SnZnOₓ, AlN, NbO, NbN, TiO₂, SiO₂, Al₂O₃, MgF₂, AlF₃, or thin metal layers, in particular layers of silver, gold, copper, titanium, niobium, silicon, aluminum, nickel-chromium (NiCr) alloy, stainless steel, or alloys of these metals.

One of the main surfaces of the outer layers may be textured using any known texturing process, for example by embossing the surface of the substrate, heated beforehand to a temperature at which it is possible to deform it, in particular by rolling by means of a roller having, at its surface, a texture complementary to the texture to be formed on the substrate; by abrasion by means of abrasive particles or surfaces, in particular by sandblasting; by chemical treatment, in particular treatment with acid in the case of a glass substrate; by molding, in particular injection molding, in the case of a substrate made of thermoplastic polymer; or by engraving.

The features of the texture of each contact surface between two adjacent layers of the layered element which are one dielectric and the other metal, or which are two dielectric layers of different refractive indices, may be distributed randomly over the contact surface. As a variant, the features of the texture of each contact surface between two adjacent layers of the layered element which are one dielectric and the other metal, or which are two dielectric layers of different refractive indices, may be distributed periodically over the contact surface. These features may in particular be cones, pyramids, grooves, ribs or wavelets.

FIG. 5 illustrates one particular embodiment of the invention, in which the layered element (1) comprises a laminar assembly (3) inserted between the outer layers (2, 4) and formed of 4 (four) intermediate layers (3¹, 3², 3³ and 3^{k}), each intermediate layer being, in this case, a single dielectric layer with a refractive index that is different from that of the outer layers, the contact surfaces of the intermediate layers (3¹, 3², 3³ and 3^{k}) and of the outer layers (2, 4) all being textured and parallel to one another in order to exhibit satisfactory diffuse reflection and transparency properties.

More specifically, the laminar assembly (3) shown in cross section in FIG. 5 is divided into 6 (six) regions (A, . . . , F), each region exhibiting, in reflection, a color that is distinct from that of the adjacent regions.

Thus, in the regions A, B and D, the colorimetric characteristics of the laminar assembly (3) in reflection are dictated by the nature and thickness of the intermediate layers 3¹ and 3². It should be noted in this regard that the regions A and D exhibit the same color in reflection, although these two regions are not adjacent. The region C is a portion of overlap of the intermediate layers 3¹ and 3². Given its total thickness, and the particular arrangement of its layers, this region B exhibits, in reflection, a color that is distinct from that of the adjacent regions B and D. It should additionally be noted that this region C exhibits a different color in reflection depending on whether it is observed from the top side of the layered element 1, or from the underside. Similarly, the region F is characterized by the overlap of the intermediate layers 3¹ and 3³, and the region E is characterized by the overlap of the layers 3¹, 3³ and 3^{k}.

According to one alternative embodiment (not illustrated), the 4 (four) intermediate layers (3¹, 3², 3³ and 3K) are all of the same nature. If the thicknesses differ from one intermediate layer (3¹, 3², 3³ and 3K) to another, each region consequently exhibits a different color in reflection. However, if the thicknesses of the intermediate layers are identical, what is obtained is a first color in the regions A, B and D, a second color in the regions B and F, and a third color in the region E.

According to the particular embodiment illustrated by FIG. 5, the laminar assembly (3) is deposited on one portion only of the textured main surface of the lower outer layer (2). The bottom and pattern layers are therefore added only to this portion of the lower outer layer. In the regions not covered by this laminar assembly, the light transmission ratio is increased. In general, the layered element therefore exhibits higher transmittance.

According to one alternative embodiment (not shown), the laminar assembly (3) is deposited over the entirety of the textured main surface of the lower outer layer (2).

According to one particular embodiment, two deposition passes are carried out by magnetron. A mask is then introduced into the deposition chamber for at least one of the 2 (two) depositions.

According to one alternative embodiment, two deposition passes are carried out by liquid deposition. In particular, according to one particular embodiment of the invention, deposition step b) is carried out by screen printing and comprises:

b1) positioning a screen-printing screen facing the textured main surface (2B) of the lower outer layer (2),
b2) depositing a dielectric layer with a refractive index (n3) that is different from that of the outer layers or a metal layer on the screen-printing screen and transferring said layer onto the substrate, using a squeegee.

Examples of suitable polymers for the transparent substrate include, in particular, polyesters such as polyethylene terephthalate (PET), polybutylene terephthalate (PBT), polyethylene naphthalate (PEN); polyacrylates such as polymethyl methacrylate (PMMA); polycarbonate; polyurethane; polyamides; polyimides; fluoropolymers such as ethylene tetrafluoroethylene (ETFE), polyvinylidene fluoride (PVDF), poly chlorotrifluoroethylene (PCTFE), ethylene chlorotrifluoroethylene (ECTFE), fluorinated ethylene-propylene (FEP) copolymers; photocrosslinkable and/or photopolymerizable resins, such as thiol-ene resins, polyurethane resins, urethane-acrylate resins, polyester-acrylate resins.

Patent application FR 1854691, filed 31 May 2018 by SAINT-GOBAIN GLASS France, demonstrates, through comparative measurements of surface topography, of gain, of light transmission, of haze in transmission and of clarity, that depositing an intermediate layer by screen printing makes it possible to retain optical properties close to those of the laminar assemblies for which this intermediate layer is deposited by magnetron sputtering, in terms of both light transmission and reflection.

To highlight the effect that the nature of the intermediate layers, their respective thicknesses, the process of their deposition and/or their order of arrangement may have on the colorimetric characteristics of the laminar assembly formed by these intermediate layers, a series of tests has been performed with a transparent layered element comprising the following stack:
a lower outer layer 2: textured substrate made of clear or extra-clear glass that is at least partly textured, for example an SGG Satinovo glass sold by Saint-Gobain Glass, with a thickness of 4 mm, having on its textured surface a peak-to-valley height (Rz) approximately equal to 10.6 μm, measured using a 15-800 micron band-pass filter (ET 0.9−min−8 max 13.4 for a measured area of 2×2 mm₂),
a laminar assembly 3, the composition of which varies according to the samples being studied, as described in more detail in the remainder of the description,
an upper outer layer 4: interlayer sheet, for example made of PVB, which has substantially the same refractive index as the lower outer layer 2, and which conforms to the texture of the textured main surface 3B of the laminar assembly 3.

According to one particular embodiment, the interlayer sheet 4 is calendered via its outer surface to a flat substrate made of clear or extra-clear glass, for example SGG Planilux glass sold by Saint-Gobain. Three samples were analyzed according to the characteristics of the laminar assembly 3 acting as central layer.

A first sample, called “magnetron”, comprises a laminar assembly 3 deposited exclusively by magnetron, and formed of the stack of a first layer of titanium oxide (TiO₂) of 65 nm, of a layer of silicon nitride (SiN) of 55 nm, and of a second layer of titanium oxide (TiO₂) of 385 nm in thickness.

A second sample, called “Lustreflex magnetron”, comprises a sol-gel layer obtained by curing a sol-gel solution comprising titanium tetraisopropanolate, for example a LustReflex Silver solution sold by Ferro and described in document WO2005063645, said cured layer having a thickness of around 75 nm and consisting mostly of grains of titanium dioxide at a fraction by volume higher than 95%, preferably higher than 97%. This sol-gel layer is covered with the TiO₂/SiN/TiO₂ stack described above, and deposited by magnetron.

A third sample, called “magnetron+Lustreflex”, is the inverse of the second sample. It is thus formed by the TiO₂/SiN/TiO₂ stack described above, on which a LustReflex solution, with a cured thickness of about 75 nm, is deposited.

On the basis of the vertical profiles of each of these three samples, the values of light reflection (RL) in the visible in %, measured according to the standard NF EN 410 (illuminant D65; 2° observer), and the colorimetric characteristics in reflection of these three samples, defined by the Cartesian coordinates (Lw, a*, b*) in the CIELAB 76 (CIE 1976) space with, as source, average daylight (D65), have been measured and are given in table 1 below.

TABLE 1

| | | LustReflex + | Magnetron + |
|---|---|---|---|
| Sample type | Magnetron | Magnetron | LustReflex |
| RL (%) | 20.9 | 14.6 | 19.6 |
| a* | −22 | −7 | 6 |
| b* | 1 | −18 | 2 |

A difference in color in reflection is observed between, on the one hand, the first sample, “magnetron”, and, on the other hand, the second and third samples, which comprise an additional LustReflex layer.

The second and third samples differ from one another in the arrangement of this LustReflex layer with respect to the magnetron layer. Because of this, the color obtained in reflection varies significantly between these two samples.

1. A transparent layered element comprising at least one lower outer layer and one upper outer layer which each form a smooth outer main surface of the layered element, and which consist of dielectric materials that have substantially a same refractive index, wherein:
said layered element comprises a laminar assembly inserted between the at least one lower and upper outer layers and formed of a plurality of intermediate layers, each intermediate layer being either a single layer which is a dielectric layer with a refractive index that is different from that of the at least one lower and upper outer layers or a metal layer, or a stack of layers which comprises at least one dielectric layer with a refractive index that is different from that of the at least one lower and upper outer layers or a metal layer,
each contact surface between two adjacent layers of the layered element, one of which is dielectric and the other of which is metal, or which are two dielectric layers with different refractive indices, is textured and parallel to the other contact surfaces, and
said laminar assembly exhibits, in reflection, at least two adjacent regions having colors that are distinct from one another.

2. The transparent layered element as claimed in claim 1, wherein at least one intermediate layer forming a pattern layer partially overlaps another intermediate layer forming a bottom layer, a corresponding overlapping portion between the pattern layer and the bottom layer forming, in reflection, a region having a color that is distinct from at least one adjacent region.

3. The transparent layered element as claimed in claim 1, wherein at least one first intermediate layer forms a cross-inclusion within a second intermediate layer, and wherein said first and second intermediate layers exhibit, in reflection, colors that are distinct from one another.

4. The transparent layered element as claimed in claim 1, wherein at least one intermediate layer is obtained by magnetic-field-assisted cathode sputtering and/or wherein at least one intermediate layer is obtained by screen printing.

5. The transparent layered element as claimed in claim 1, wherein at least one of the lower and upper outer layers is absorbent in the visible spectrum.

6. The transparent layered element as claimed in claim 1, wherein the intermediate layers are all conductive.

7. A process for producing a layered element, comprising:
a) providing a lower outer layer having a textured main surface and another main surface that is smooth;
b) depositing a plurality of intermediate layers successively and conformably on said textured main surface, each intermediate layer being either a single layer which is a dielectric layer with a refractive index that is different from that of the outer layers or a metal layer, or a stack of layers which comprises at least one dielectric layer with a refractive index that is different from that of the outer layers or a metal layer, said intermediate layers forming, after deposition, a laminar assembly which exhibits, in reflection, at least two adjacent regions having colors of which that are distinct;
c) forming an upper outer layer on that textured main surface of the laminar assembly which is opposite the lower outer layer, where the lower and upper outer layers are composed of dielectric materials having substantially a same refractive index.

8. The process for producing a layered element as claimed in claim 7, wherein step b) of depositing the laminar assembly comprises:
depositing a first intermediate layer forming a bottom layer, then
depositing a second intermediate layer forming a pattern layer such that the pattern layer partially overlaps said bottom layer, and a corresponding overlapping portion between the pattern layer and the bottom layer forms, in reflection, a region having a color that is distinct from at least one adjacent region.

9. The process for producing a layered element as claimed in claim 7, wherein step b) of depositing the laminar assembly comprises:
depositing a first intermediate layer forming a bottom layer such that the bottom layer comprises a through-window, then
depositing a second intermediate layer forming a pattern layer having at least a portion that is deposited in said through-window in the bottom layer, such that the pattern layer forms a cross-inclusion within said bottom layer,
said first and second intermediate layers exhibiting, in reflection, colors that are distinct from one another.

10. The process for producing a layered element as claimed in claim 7, wherein in step b) of depositing the laminar assembly, at least one intermediate layer is deposited by magnetron cathode sputtering.

11. The process for producing a layered element as claimed in claim 7, wherein in step b) of depositing the laminar assembly, at least one intermediate layer is deposited by screen printing and comprises:
b1) positioning a screen-printing screen facing the textured main surface of the lower outer layer, and/or another intermediate layer of the laminar assembly,
b2) depositing a dielectric layer with a refractive index that is different from that of the lower and upper outer layers or a metal layer on the screen-printing screen and transferring said dielectric layer onto the substrate.

12. The process for producing a layered element as claimed in claim 7, wherein the laminar assembly is formed by depositing, on the textured main surface of the lower outer layer, a layer of a photocrosslinkable and/or photopolymerizable material.

13. The process as claimed in claim 7, wherein the upper outer layer is formed by depositing, on that textured main surface of the laminar assembly which is opposite the lower outer layer:
either a layer of a photocrosslinkable and/or photopolymerizable material which has substantially the same refractive index as the lower outer layer,
or a layer based on polymer material, suitable for being shaped against the textured main surface of the laminar assembly by compression/heating.

14. A glazing unit for a vehicle, for a building, for street furniture, for interior furnishings, for a display screen and/or for a head-up display system, said glazing unit comprising a layered element as claimed in claim 1, said intermediate pattern layer being adapted to reveal a given pattern by reflection and/or transmission.

15. A projection or back-projection method, comprising providing a glazing unit as claimed in claim 14 as a projection or back-projection screen, and a projector, and projecting, using the projector, images that are visible to viewers on one of the sides of said glazing unit.

16. The process for producing a layered element as claimed in claim 10, wherein the at least one intermediate layer is a bottom layer.

17. The process for producing a layered element as claimed in claim 11, wherein the at least one intermediate layer is a bottom layer.

18. The process for producing a layered element as claimed in claim 11, wherein the depositing and the transferring are carried out using a squeegee.
